(19) United States
(12) Patent Application Publication
(10) Pub. No.: US 2002/0116510 A1
(43) Pub. Date: Aug. 22, 2002

(54) Method and system for dataflow management in a communications network

(76) Inventors: Stephen R. Bacso, Kitchener (CA); Rene J. Juneau, Thornhill (CA); Sanjeev Shankar, Waterloo (CA); Bruce D. Scanlan, Waterloo (CA)

Correspondence Address: SHUMAKER & SIEFFERT, P. A., 8425 SEASONS PARKWAY, SUITE 105, ST. PAUL, MN, 55125, US

(21) Appl. No.: 09/991,563

(22) Filed: Nov. 20, 2001

(30) Foreign Application Priority Data
Nov. 20, 2000 (CA) 2,326,368

(51) Int. Cl. G06F 15/16

(52) U.S. Cl. 709/230

(57) ABSTRACT

The present invention relates to a method and system for dataflow management in interactive communications networks. In accordance with the present invention, there is provided a method for dataflow management in interactive communications networks, the method comprising the steps of: determining characteristics of network components; and managing dataflow in accordance with said determined characteristics. In accordance with the present invention, there is provided a method for targeting content to users in a communications network; the method comprising the steps of: determining targeted user characteristics; and presenting content in accordance with said characteristics.

### Priority Claim

The present application claims priority from Canadian Patent Application 2,326,368 filed Nov. 20, 2000, and pending U.S. patent application Ser. No. 09/687,449 filed Oct. 13, 2000 entitled ‘Method and System for Targeted Advertising’, the contents of which are herein incorporated by reference.

### FIELD OF THE INVENTION

The present invention relates generally to methods and systems for the management of interactive television systems, and more particularly to a method and system for dataflow management in a communications network.

### BACKGROUND OF THE INVENTION

While television is still by far the most popular medium for entertainment and information, television technology had until recently remained relatively unchanged since its introduction in the 1950s. However, the recent emergence of digital television environments has reflected the convergence of conventional television broadcasting and the digital format.

Existing digital television systems, whether broadcast systems such as over-the-air NTSC or ATSC, cable television, DTH satellite or microwave, point-to-point data systems like the Internet, or switched systems using DSL in all its variants including ADSL, dual ADSL and VDSL, now simultaneously transmit hundreds, even thousands of services, each including one or more streams of audio, video, data, or interactive applications.

A problem with substituting, targeting or enhancing advertisements or existing broadcast systems is that the start time is not absolute. A television program does not always start exactly on time, and even if it does the start time is relative to the content provider's own clock. Even if all content providers operate from the same master clock, factors like satellite transmission delay, MPEG packet jitter and re-clocking and other effects will result in start time variations for different programs when received by the operator. Interactive TV and other systems have their own separate and accurate timing models.

What is needed is a method that provides improved response times for delivering data and utilization of legacy systems to provide backwards compatibility.

For the foregoing reasons, there is a need for an improved method of dataflow management.

### SUMMARY OF THE INVENTION

The present invention is directed to a method and system for dataflow management in a communications network.

In accordance with the present invention, there is provided a method for dataflow management in interactive communications networks, the method comprising the steps of: determining characteristics of network components; and managing dataflow in accordance with said determined characteristics.

In accordance with the present invention, there is provided a method for targeting content to users in a communications network; the method comprising the steps of: determining targeted user characteristics; and presenting content in accordance with said characteristics.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

These and other features, aspects, and advantages of the present invention will become better understood with regard to the following description, appended claims, and accompanying drawings where:

These and other features, aspects, and advantages of the present invention will become better understood with regard to the following description, appended claims, and accompanying drawings where:

FIG. 1 is an overview of a system for targeted content presentation in communications networks according to an embodiment of the present invention;

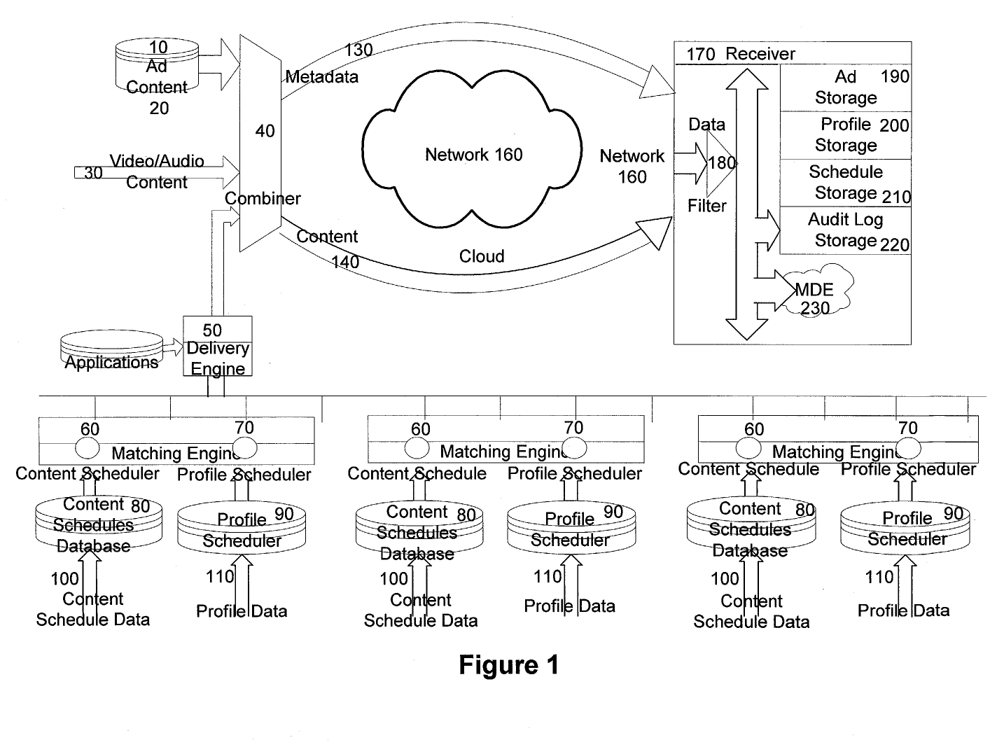

FIG. 2 shows an automated reporting system in accordance with the present invention;

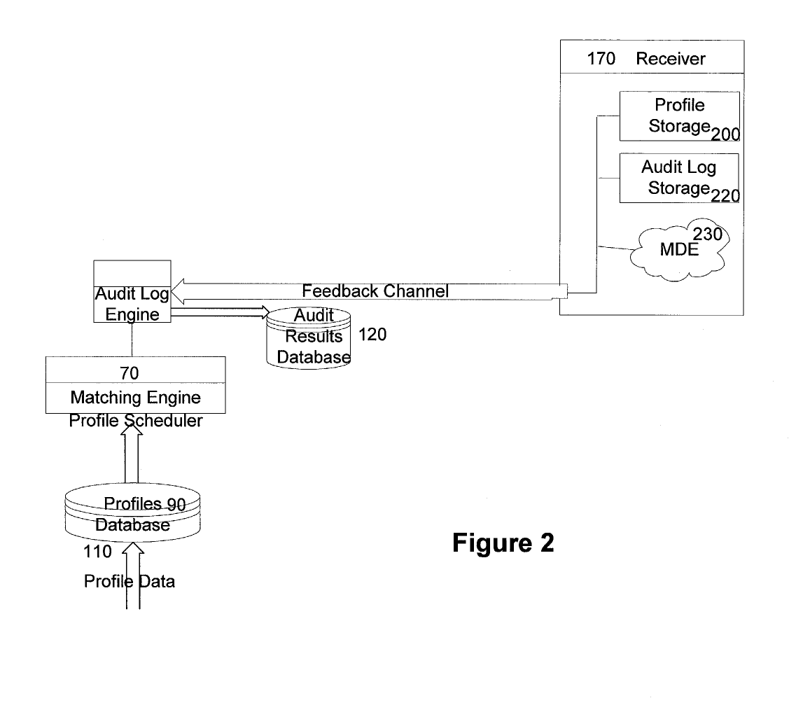

FIG. 3 shows a system for presenting target content system in accordance with the present invention;

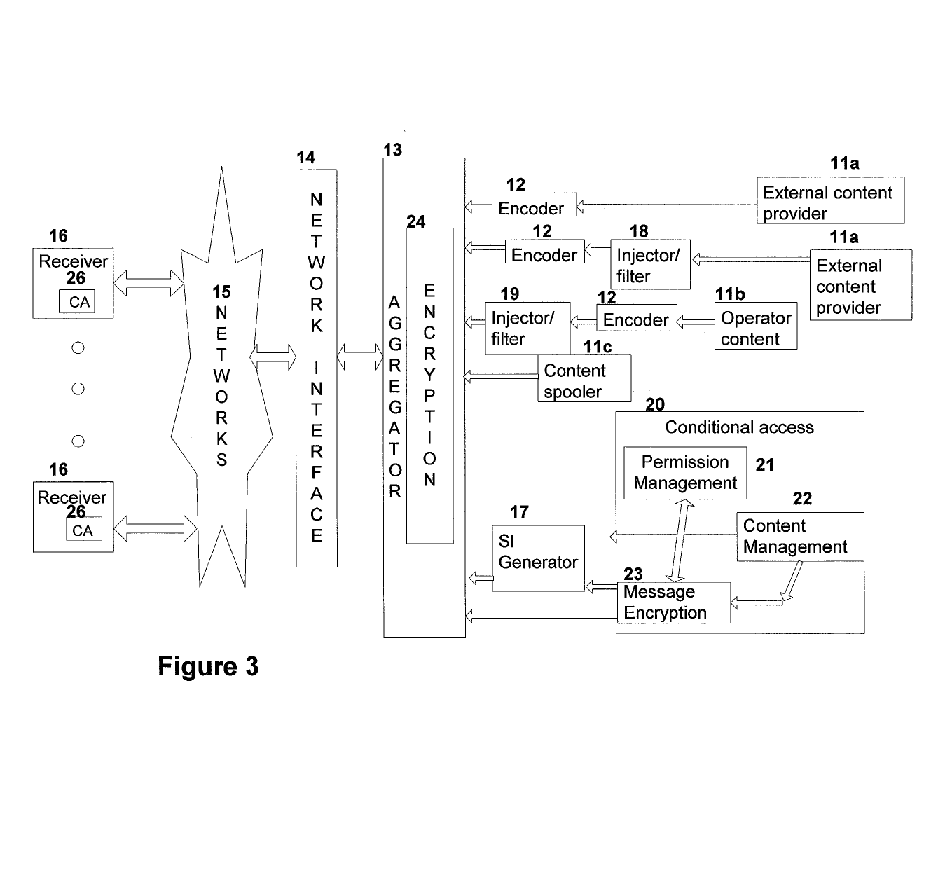

FIG. 4 shows a receiver system in accordance with the present invention;

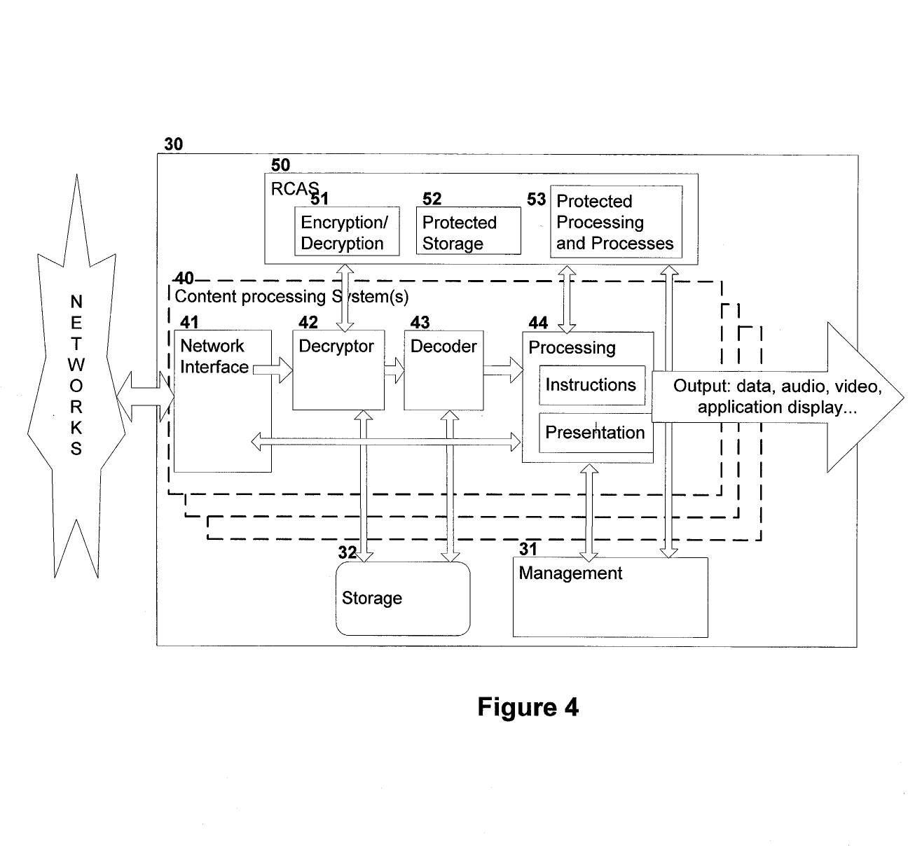

FIG. 5 shows a method for presenting targeted content in accordance with the present invention;

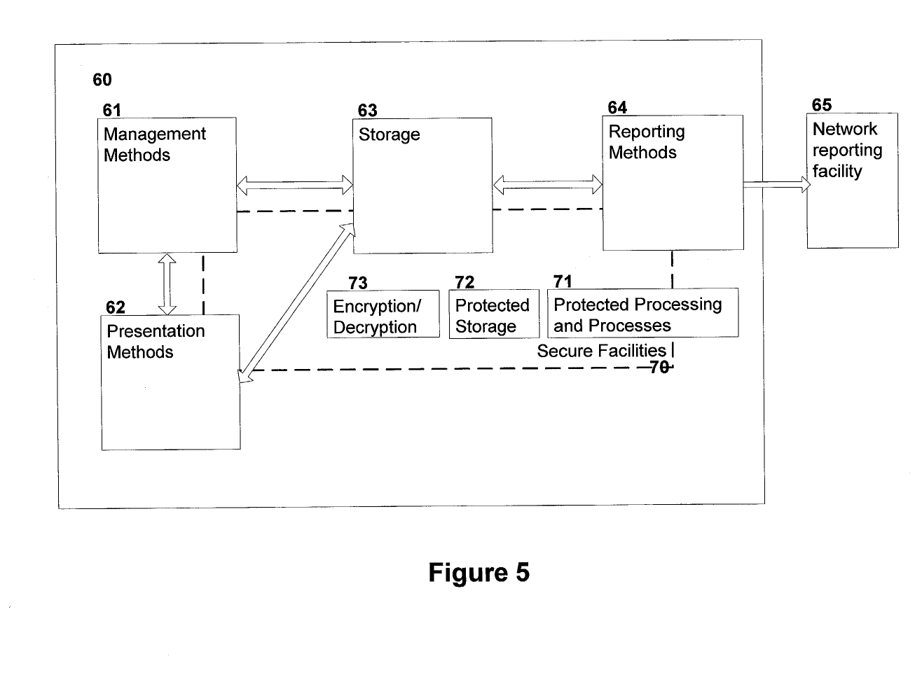

FIG. 6 shows a method for presenting targeted content in accordance with the present invention;

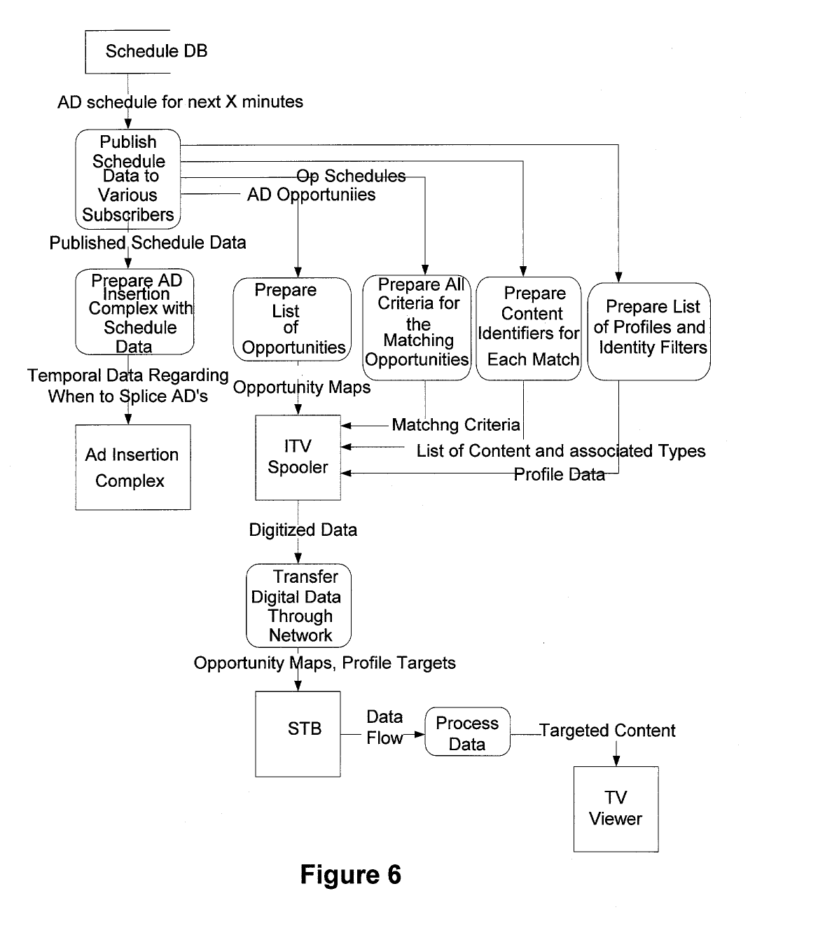

FIG. 7 shows a method for presenting targeted content in accordance with the present invention;

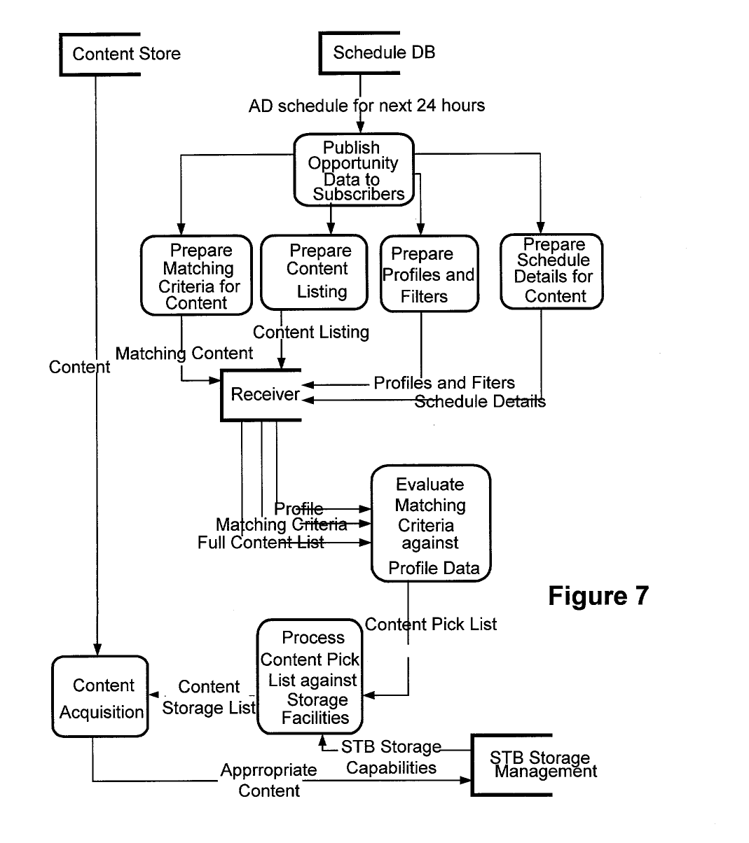

FIG. 8 shows a method for presenting targeted content system in accordance with the present invention;

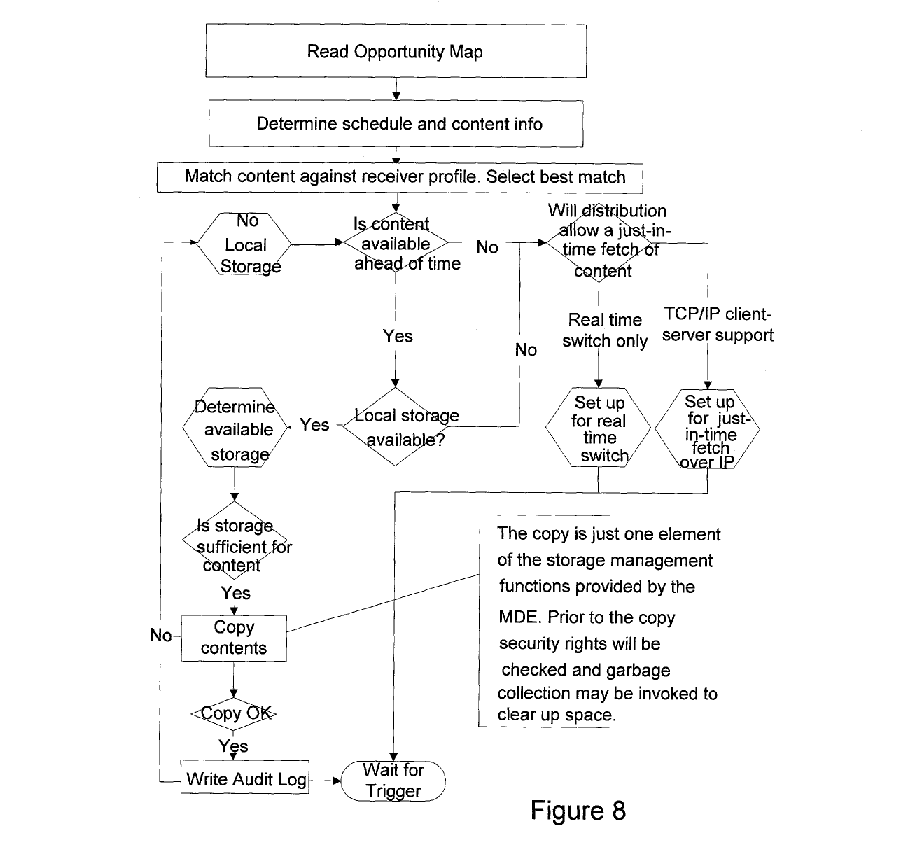

FIG. 9 shows a method for presenting targeted content system in accordance with the present invention;

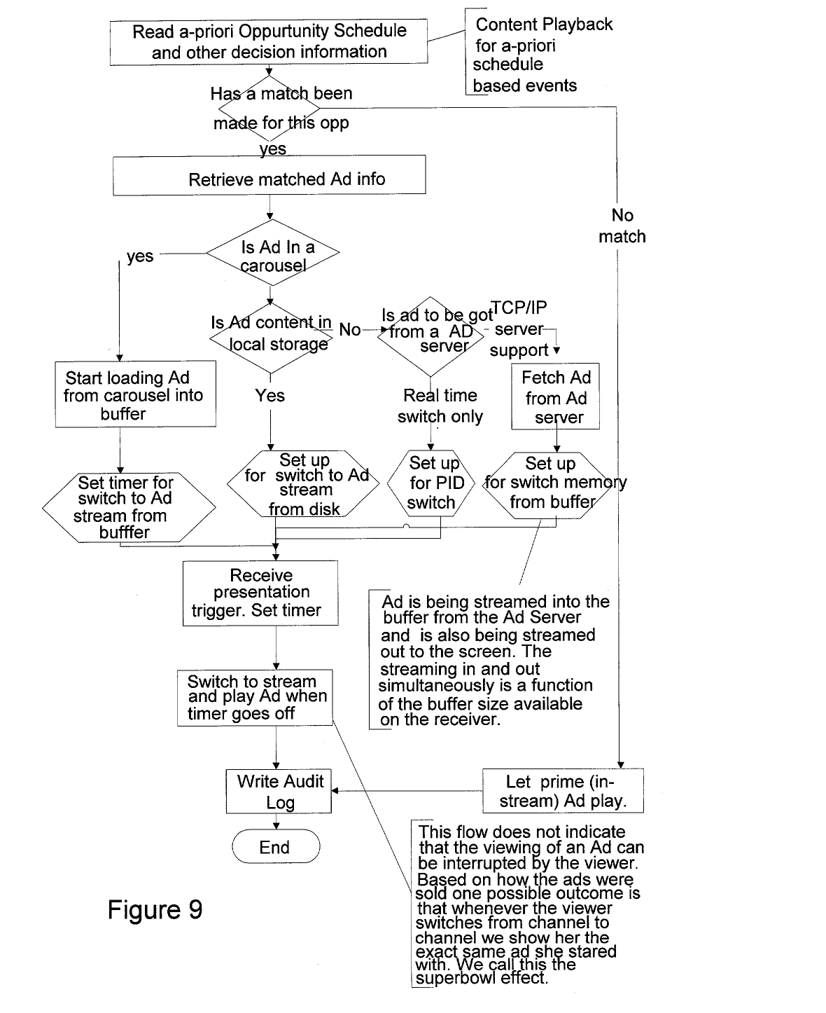

FIG. 10 shows a method for presenting targeted content system in accordance with the present invention; and

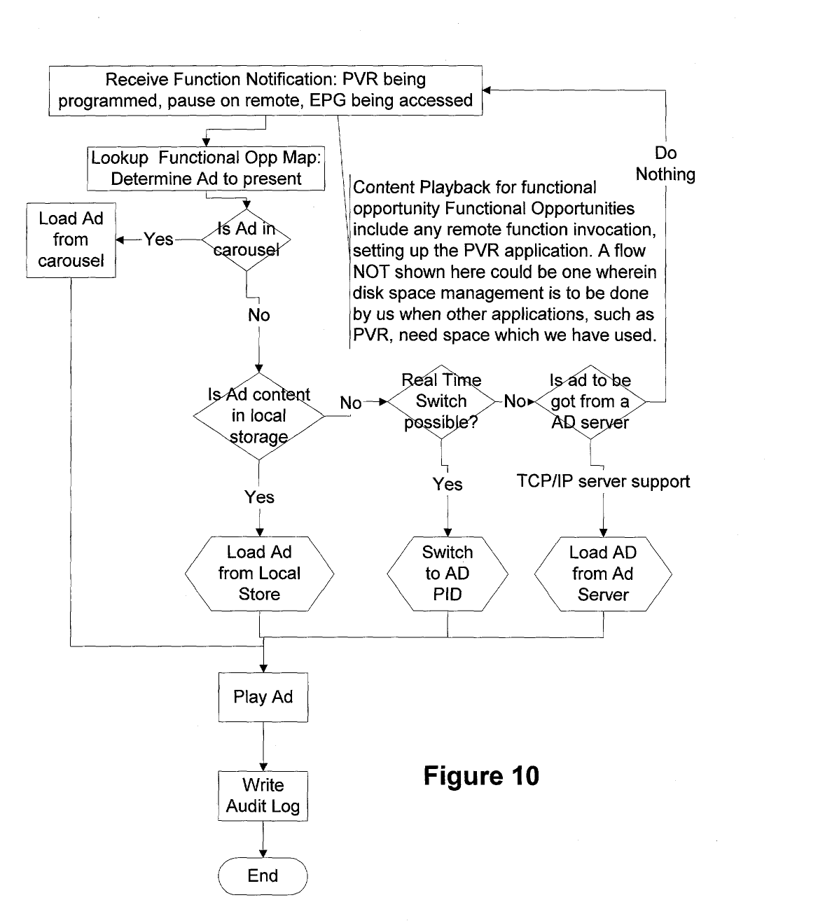

FIG. 11 shows a method for presenting targeted content system in accordance with the present invention.

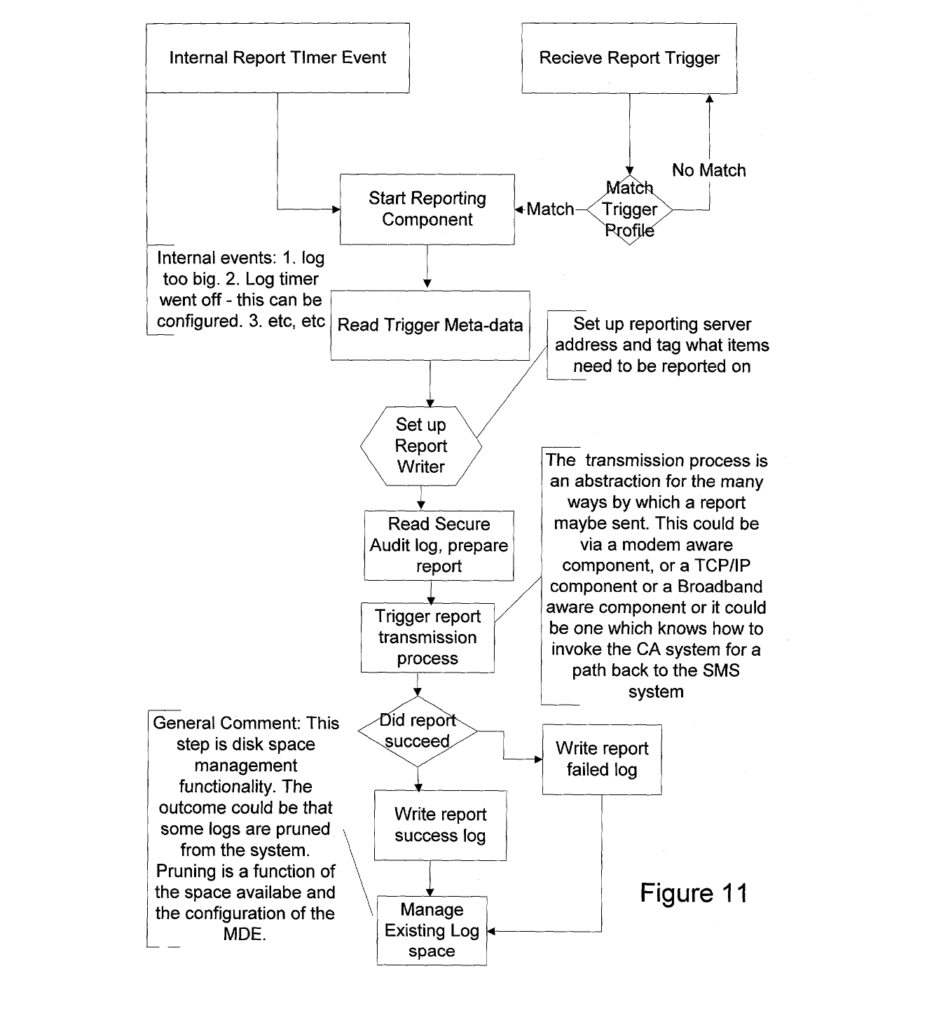

### DETAILED DESCRIPTION OF THE PRESENTLY PREFERRED EMBODIMENT

The present invention is directed to a method and system for dataflow management in interactive communications networks.

In accordance with the present invention, there is provided a method for dataflow management in interactive communications networks, the method comprising the steps of: determining characteristics of network components; and managing dataflow in accordance with said determined characteristics.

In accordance with the present invention, there is provided a method for targeting content to users in a communications network; the method comprising the steps of: determining targeted user characteristics; and presenting content in accordance with said characteristics.

The invention is suitably used with Cellular telephony; Cable networks; Consumer kiosks such as ATMs; DSL; and IP based networks.

The viewer data can be received in encrypted or unencrypted format. In this embodiment, to prevent unauthorized access, the data will be kept in encrypted format within the facilities of a conditional access system (CAS). Multiple instances of the Micro Decision Engine (MDE) can be generated to match both the capabilities and requirements of the combiner, and the capabilities of the various receiver models on the network.

The DE communicates with head-end hardware to orchestrate the delivery of targeting information to the MDE. Targeting information includes bandwidth availability, parametric data, selection triggers real-time cues, decision-making applications and timing and synchronization information from sources such as internal clocks, external reference clocks and time, relative time from triggers within content sources, and derived time from activities such as MPEG-2 video compression timing streams. It can also provide the head-end's broadcast systems with the schedule for the streaming of default or prime ads within broadcast video streams.

The DE determines the optimal method of delivering the package(s) to the MDE using techniques such pre-time, just-in-time and repeated transmission of the packages to ensure that the MDE has sufficient choices and time to acquire content, to make an appropriate match and present the data. Before transmitting the data it will ensure that the meta-data describing the matching requirements are suitable for the target MDE's. The DE using data/object carousels and/or other data transport mechanisms sends meta-info data. The structure of the carousel will be a contract between the DE and the MDE. The Matching Engine and the DE combine to decide the relevance of targeting information in the carousel. Understand and manage latencies in the delivery processes, such as creation of carousels.

The combiner is responsible for providing the delivery engine with a means to communicate with a network system for the purposes of streaming targeting content and applications. It understands how to create a middleware specific object carousel (OC), which is what will be delivered to the MDE by the broadcast system. This component provides a standard interface to the delivery engine for different Ad Carousel Management and delivery systems. This component isolates the delivery engine from implementation specifics of Ad Carousel systems. The delivery engine uses the combiner component to generate OC based on Ad dependant data such as the information generated by the OPE and Ad independent data.

In an embodiment, the content is an audio and video signal from a broadcaster, and the encoder is an MPEG-2 compressor which converts the signal from analog to digital format and then compresses and synchronizes the components into MPEG-2 data streams. The aggregator is an MPEG-2 multiplexer that creates a multiplexed transport stream delivered to the network interface, which in this case is a modulator appropriate to a cable television network. The network is the system of amplifiers, transmitters, re-transmitters, copper cable, fiber optic systems, switches and routers used for distribution of the signal. The receivers are connected to the cable network, and communicate back with the operator using Internet and/or other command protocols supported by the network.

A receiver's functions and facilities can be contained within a receiver on the viewing premises or distributed throughout a network. The receiver can have a plurality of content processing systems (CPS). Each CPS requires a network interface for communication to and from the operators' network(s), a decryptor for deciphering any secured information, a decoder for converting from the network format to the viewing or usage format, and a processing element for handling any instructions, graphics processing, multi-media combining or other formatting required before presentation to the user. A management system co-coordinates the operation of the various functions. Content storage is used to record information pertinent to the usage of the system, and for content storage and playback.

Before allowing content to pass through the decryption, decoding and other steps required for viewing or usage, the management system can communicate with the CAS to determine if access is allowed or to obtain access through purchasing or other mechanisms, as is typical in impulse pay-per-view purchases. The CAS process can include protected storage, processing and processes, access to which can be restricted through interfaces and protocols. Separate encryption and decryption facilities can be included for secure management of communications to and from the CAS.

Other examples of CAS include digital television conditional access systems implemented with individual encryption of each content stream, encryption key generation systems, command and authorization streams which are also encrypted, and capture, decryption and storage of CA permissions within the receiver or separate facilities such as a smart card within the receiver. Systems for managing commercial transaction may provide similar functions to the CAS in the receiver, operating in separate facilities or integrated with the CA CAS system. As another example, the receiver can perform an authorization check whenever access to content is requested, as implemented on switched packet networks using TCP/IP, ATM and other protocols, including the Internet and various authorization schemes supported by servers, and digital subscriber line (DSL) distribution networks, including the ADSL, VDSL and other implementations. Other security systems and authorization mechanisms will occur to those of skill in the art.

For example, when using xDSL equipment or the Internet, a channel change request to a receiver sends a signal to control equipment on the operator's network that changes the program stream being transmitted to the receiver. Embodiments can include a plurality of content processing systems, for example a receiver may have multiple processing streams to allow simultaneous processing of multiple streams for picture-in-picture viewing, watching one program while recording another to storage, or surfing the Internet while watching a television program. Storage may be included in the receiver and/or available from a network resource.

In another embodiment, content storage, CAS facilities and other functions of the receiver can be provided or augmented by sharing resources among one or more receivers and equipment accessible to receivers on a network within the viewer's premises. Individual receivers can share disk space among them, personal computers on the network can receive alternate versions of content that can be selected by the targeting and matching processes, and storage on the personal computers can be used to record content. Authorization, logging and other facilities may be performed on one device for other connected devices.

Embodiments of the processing and management components can receive, process and present to the viewer applications that integrate text, data, graphics and audio/video content, interact with the user for input, and provide feedback across a network connection. Implementations can take the form of an embedded software system with required functions, an operating system with integrated functions, or applications and libraries accessible to an operating system or embedded system.

In one embodiment, content and opportunity descriptors are provided as data in a joint stream or in separate streams to a process on the receiver. The format is appropriate to the network, and examples include DVB TCP/IP streams on a satellite network and an IP data-casting stream on the Internet. Multiple instances of descriptor and content streams can occur, each associated with a content service like a television channel, or the content streams can be in streams independent of the content service.

In another embodiment, the content and opportunity descriptors are included in the vertical blanking interval or other portion of the video signal as is done today for closed captioning, teletext and analog TV ATVEF transport A, or MPEG mechanisms for carrying closed captioning fields and related data within picture headers and control information.

In another embodiment, the content and opportunity descriptors are included in interactive content streams as data, functions, functions with parameters, and/or function calls to functions already stored within the receiver.

In another embodiment, the content and opportunity descriptors are included in fields within other tables and Service Information (SI) structures of the underlying medium. Within DVB systems, the content and/or opportunity descriptors can be carried in one or more private descriptor fields of the Event Information Table (EIT) carrying EPG content.

Content and opportunity descriptors are not necessarily transmitted separately. In a simplified implementation, the content and opportunity descriptors can all be included within a function call, with the function representing the method of the opportunity descriptor.

As described in prior art, multiple versions of a television channel can be transmitted synchronously, and using a variety of mechanisms based on user input, the receiver can switch between the different channels to create a custom version of the program.

This invention enables several mechanisms for synchronous content transmission. One method involves synchronization of multiple streams of unrelated content. The streams are related only for targeting purposes, and not by their content. Each stream includes different ads, however the timing of the ads is synchronized across the streams. At the start of each ad, the receiver can switch to a different channel for the duration of the ad if the ad on the other channel is determined to be more appropriate, or if it is a version of an ad that has not been seen by the viewer.

Another method involves adding additional streams for alternate versions of the content. As in the first method, the streams are linked to a plurality of content streams that are related only for management purposes, and not by content. By scheduling advertisements at different times on the content streams, the alternate content streams can be shared among the principal content streams.

Another method makes capacity available by manipulating content streams to eliminate redundancy caused by simultaneous substitution on networks where regulations require that when the same program is broadcast simultaneously from a local provider and a foreign provider, that the local provider's program replace the foreign provider's program on the foreign channel broadcast. Current network implementations result in the local program being transmitted redundantly on both channels.

Another method makes capacity available by placing content on services that are not broadcast 24 hours a day. During the off periods, the bandwidth of the services can be used either within the service definitions, or as separate services that use the bandwidth resources of the off-air services.

In switched environments such as DSL networks and video speed Internet with sufficient pre-roll time content can be queued and selected at the appropriate time. Within xDSL and Internet environments, a single stream of content can be multicast to a plurality of receivers. Any network mechanisms can be used for asynchronous content transmission. Content on these networks can be transmitted in real-time, or slower or faster than real-time at fixed or variable speeds at alternate times, using transmission formats different from the normal video transmission. For example, a satellite stream for alternate content being transmitted asynchronously may consist of broadcast TCP/IP file transfers within DVB streams, instead of the MPEG-2 packetization normally expected of video streams.

The asynchronous acquisition of content is based on the capabilities of the receiver, and can be done in parallel with viewing activities, and/or when there is no viewer usage of the receiver. In one embodiment, a satellite or cable receiver with disk storage capability and a single content processing system can use the receiver tuning and acquisition facilities when the user has indicated that the receiver is not being used by pressing an OFF button, or when the viewer is watching content from the disk drive instead of content from the satellite.

In another embodiment, a satellite or cable receiver has the functionality dual content processing systems for record-while-viewing and picture-in-picture capability. If neither of these capabilities is being used, then the receiver can acquire content anytime. In another embodiment, a satellite or cable receiver also has Internet access of sufficient speed to acquire content from the Internet given a sufficient amount of time to accommodate speed and latency delivery problems.

The receiver management methods are processes for accessing, retrieving, storing and deleting content and data. Embodiments of the receiver will vary in their capabilities, and in particular in the number of instances of the content processing system. Embodiments of the receiver can acquire content descriptors and content based on the transmission methods described earlier, and will vary based on the implementation of the receiver. Examples of content descriptor acquisition include the following:

As part of a completely independent content acquisition stream, this method requires that the receiver either be equipped to handle a separate stream other than the viewed stream, or that the content from such a stream be acquired when the receiver is not used for viewing. In a cable or satellite receiver, this requires component(s) to provide separate frequency tuning, demodulation and decrypting functions, or access to another source or technology like the Internet, as part of a co-located stream that can be processed while content is being viewed, as part of a dynamic stream that includes both content descriptors and content opportunities, as part of a response to a viewer request for content, in which descriptions of alternate versions or segments of the content are included by sending a message directly to the receiver.

The management method also receives characteristic information on the viewers from the operator. This data may be based on the subscription information provided to the operator by the viewer, or information the operator has acquired from other sources. When an opportunity for targeting contents results in the switch from one content stream to another, whether the content is from another stream, storage or another source, the system must switch as seamlessly as possible from the original to the alternate stream.

Access to an alternate stream may not be instantaneous. Preparation required before switching streams can include locating and retrieving content from disk, access latency related to the storage devices and network performance. Examples include disk access and Internet router and transmission latency for concurrent streams, tuning to an alternate frequency and starting the conditional access decryption process.

Another problem is that the start time is not absolute. A television program does not always start exactly on time, and even if it does, the start time is relative to the content provider's own clock. Even if all content providers operate from the same master clock, factors like satellite transmission delay, MPEG packet jitter and re-clocking and other effects will result in start time variations for different programs when received by the operator.

An advance pre-roll trigger can be used to within the opportunity to descriptor to advise the receiver that the content substitution must start in an amount of time relative to a reference clock, at an absolute time relative to a reference clock, or in an amount of time relative to a data trigger. The exact method will depend on the capabilities of the receiver.

In one embodiment, the timing mechanisms of the interactive TV system used are sufficient to provide the exact timing. In one embodiment, the discrete tone multi-frequency (DTMF) or a control signal embedded within an MPEG stream in the source stream is used to generate the data required in the opportunity descriptor to describe and accurate start point. DTMF signals are used in broadcast streams to announce the arrival of an advertisement in a fixed time signal, and are commonly used for ad insertion in cable companies, as is known to those of skill in the art.

The injection filters detect the time at which the DTMF signal occurs on a reference clock signal, and the opportunity descriptor characteristic field is generated with a start time relative to the same clock signal or to absolute time with respect to a reference clock. The reference and relative clocks can be MPEG presentation time stamps (PTS) or display time stamps (DTS) within the MPEG stream, or the time-of-day clock stream used in digital television broadcasts, with the DVB SI Time-Date-Table (TDT) as a prominent example.

In another embodiment, the DTMF or its MPEG equivalent is used as a trigger to generate an appropriate sequence for an interactive system like ATVEF or OpenTV. The interactivity commands and/or data sequences are injected into the content stream with appropriate commands and parameters to time the opportunity content switch relative to the insertion of the interactivity stream. This type of insertion would be provided by pre-encoding device or post-encoding device. When switching from one content stream to and from an alternative piece of content, perceptible delays are to be avoided.

In one embodiment, the receiver has a plurality of content processing systems. An alternate content processing system can be used to tune to or pre-queue from storage an alternate content stream, and seamlessly or near-seamlessly switch to the alternate content stream. When seamless or near-seamless transitions are not possible, the alternate content can be modified to accommodate delays in tuning to and returning from the alternate content selection. These modifications can include designing the content so that the start and end portions are less relevant and not significant to the message if missed; a temporal compression of the alternate content so that the start and end are blank or irrelevant for the amount of time it takes, and the message is shortened from its original length through accelerated playback or the removal of selected frames to fit within the shortened display time.

Current implementations of video copy protection schemes involve the modification or addition of components of the video to prevent recording on VCR devices. In analog video transmission, the operator on the transmitted signal performs the modification. In digital video transmission, data transmitted with the video, usually in the form of a true-or-false value, indicates that the receiver, when playing out the video, must perform the video component modification to prevent connected VCRs from recording the content.

The copy protection scheme is extended to receivers with digital storage to encompass the capabilities of the storage by assigning additional meaning to the copy protection flag. When the transmitted video has an indication of copy protection, the flag can include meanings such as the receiver is not permitted to record the content to storage, the receiver is permitted to hold only enough content in storage to allow a pause feature to be implemented. The pause feature may also include a limited amount of rewind time, the receiver is permitted to record the content to storage, but only if encryption facilities are available.

The encryption and subsequent decryption and playback, may require the facilities of the conditional access system, limitations may be placed on the playback, including time limits and number of replays, the receiver must include analog copy protection mechanisms within the video signal to prevent recording on VCRs, and the ability to record and replay and the time limits and number of replays may be subject to permissions assigned by a conditional access system, or as part of rights acquired during the purchase of a pay-per-view event.

As the current copy protection model is based on a binary true-or-false value of the copy protection flag, the copy protection flag can also be extended as a series of flags or as a data structure with multiple fields to allow explicit specification of any or all of the copy protection features listed herein. In the case where storage is located on a network facility, the storage may be shared between receivers. A request to store content is compared to other requests, and if another request has been made to store the same piece of content, the request is ignored. However, a record is made of the multiple requests, and the content is not deleted until either all requestors have issued a delete request or the temporal limits on the recording or the associated permissions have all expired.

During the recording process, the content being recorded may include one or more content targeting opportunities. Depending on the attributes described earlier in this invention for selecting targeted content, including the use of specific attributes or the receiver's capabilities, any or all of the following may be implemented in the content recording process the inclusion in the recording of all of the opportunity and content descriptors, to allow the selection of targeted content to occur during playback as it would during live airing, the recording of the content with the selection of content during opportunities being the same as that which would be made if the content was being watched live, the recording of the content with an alternate selection based on one of the variable within the matching process being an indicator of whether the content is being watched live, recorded, or watched while being recorded.

If the matching process includes a characterization of “watched while being recorded”, then the version of content that is being shown to the watching viewer may be different from the version of content being recorded, provided this capability is available within the receiver. The selection of an alternate version of content specific to an event being recorded can be implemented whether or not the recording feature is integral to the receiver. In one embodiment, the record feature consists of deferred record function available to a user on a receiver, which, when activated, consists of changing to a selected channel near the time of the start of a program, and the control through infrared signals or other protocols of an external recording device. The state of the receiver during the record process can be recognized and used as an argument within the matching algorithm.

Ad independent data is comprised of “Xlet” like executable objects to be run on set-tops and set-top profiling data. Ad independent carousel data could have a different repeat rate than ad dependant data. The rate at which the DE has the ITV spooler repeat the various chunks of data is parameterized. The configuration information may be stored in a properties file, or stored in a LDAP repository. The DE may communicate with one or more ITVS, and the ITVS systems may be heterogeneous. A key capability of the DE is its ability to manage and convert the timing and delivery requirements from the originating sources at the head-end into the appropriate forms required for a variety of combiners.

Storage could be in persistent store if such facilities are available on the box or could be in temporary storage. The MDE also interacts with receiver based conditional access systems (CAS) in order to provide security and privacy for system information. It may be part of the receiver or it may be part of a switched network fabric (xDSL). Since there are a variety of application platforms used by set top vendors, the actual implementation of the MDE may be platform dependent and each platform will have it's own version of a MDE. The MDE collects targeting content, profile information, schedule information and prepares its work environment.

When the MDE recognizes that an opportunity for targeting content will result in the switch from one content stream to another, whether the content is from another stream, storage or another source the MDE must switch as seamlessly as possible from the original to the alternate stream. Access to an alternate stream may not be instantaneous. Preparation required before switching streams includes locating and retrieving content from disk, accounting for latency related to the storage devices and network performance. Examples include disk access and Internet router and transmission latency and tuning to an alternate frequency and starting the conditional access decryption process for concurrent streams.

An advance pre-roll trigger can be used to within the opportunity to descriptor to advise the receiver that the content substitution must start in an amount of time relative to a reference clock, at an absolute time relative to a reference clock, or in an amount of time relative to a data trigger.

The exact method will depend on the capabilities of the receiver. In one embodiment, the timing mechanisms of the interactive TV system used are sufficient to provide the exact timing. In one embodiment, the discrete tone multi-frequency (DTMF) or a control signal embedded within an MPEG stream in the source stream is used to generate the data required in the opportunity descriptor to describe and accurate start point. DTMF signals are used in broadcast streams to announce the arrival of an advertisement in a fixed time signal, and are commonly used for ad insertion in cable companies, as is known to those of skill in the art.

The opportunity descriptor trigger is generated with a start time relative to the same clock signal or to absolute time with respect to a reference clock. The reference and relative clocks can be MPEG presentation time stamps (PTS) or display time stamps (DTS) within the MPEG stream, or the time-of-day clock stream used in digital television broadcasts, with the DVB SI Time-Date-Table (TDT) as a prominent example.

In another embodiment, the DTMF or its MPEG equivalent is used as a trigger to generate an appropriate sequence for an interactive system like ATVEF or OpenTV. The interactivity commands and/or data sequences are injected into the content stream with appropriate commands and parameters to time the opportunity content switch relative to the insertion of the interactivity stream. This type of insertion would be provided by pre-encoding device or post-encoding device.

When switching from one content stream to and from an alternative piece of content, perceptible delays are to be avoided. In one embodiment, the receiver has a plurality of content processing systems. An alternate content processing system can be used to tune to or pre-queue from storage an alternate content stream, and seamlessly or near-seamlessly switch to the alternate content stream.

When seamless or near-seamless transitions are not possible, the alternate content can be modified to accommodate delays in tuning to and returning from the alternate content selection. These modifications can include designing the content so that the start and end portions are less relevant and not significant to the message if missed; a temporal compression of the alternate content so that the start and end are blank or irrelevant for the amount of time it takes, and the message is shortened from its original length through accelerated playback or the removal of selected frames to fit within the shortened display time.

The ME generates a schedule that is published on the software service bus. The schedule describes advertisement opportunities that occur a-priori, the primary/default advertisement, alternate ads and meta-data/profile information for each ad slot. The DE subscribes to this information and uses it to prime ad-insertion and media object servers at the head-end. The DE also creates an opportunity map based on the schedule which describes the ad slots, content, and other meta-information which a MDE would require in order to provide the targeting and presentation function. The opportunity map also describes the mechanisms by which alternate/targeted ad content can be picked up by the MDE. The DE will then broadcast this meta-content to a set of receivers.

In an embodiment of the present invention, the system is deployed in a broadcast environment where the network operator uses satellite transmission to viewing devices and TELCO-based return to the network operator's site. In switched environments such as but not limited to DSL networks and video speed Internet, content will be queued and selected at the appropriate time. Within xDSL and Internet environments, a single stream of content will be multicast to a plurality of receivers. In this case the meta-data being sent by the DE describes the access point s at which the content will be available to the MDE.

For asynchronous content transmission, any of the network mechanisms discussed (broadcast or point-to point) can be used. Content on these networks can be transmitted in real-time, or slower or faster than realtime at fixed or variable speeds at alternate times, using transmission formats different from the normal video transmission. For example, a satellite stream for alternate content being transmitted asynchronously may consist of broadcast TCP/IP file transfers within DVB streams, instead of the MPEG-2 packetization normally expected of video streams.

In the present embodiment all the server side engines are connected by a service bus or event bus, which is essentially a software bus that uses Internet or other suitable network(s) as a physical conduit. Event bus provides a software interconnection, typically in the form of events or topics, between software applications and/or objects executing on vending interfaces, purchasing interfaces, matching engines, and delivery engines.

The DE combiner sends, via the broadcast network, meta-data and triggers to the MDE for the purposes of content delivery, capture, targeting, presentation, and feedback. Meta-information for feedback/reporting is sent via middleware infrastructures, which collect information from the combiners, and broadcast this information to the receivers using standard digital broadcast equipment such as MPEG2 multiplexes, and encoders.

The invention has a unique ability to manage feedback bandwidth depending on the broadcast system. The invention has a unique ability to adapt the reporting capability depending on receiver/feedback environment.

The invention provides the ability to target digital content based on receiver capability and viewer demographic profiles. The invention provides the unique ability to use commercial ITV systems to deliver targeting applications and content to digital receivers. The invention provides the unique ability to manage the content delivery through multiple elements of a broadcast activity such as a broadcaster to cable network to receiver.

The invention provides the unique ability to manage and synchronize content delivery across heterogeneous networks. The invention provides the unique ability to adapt receiver based targeting applications to receiver and network environments. The invention provides the ability to perform software updates in real-time and the ability of different targeting applications to configure themselves during run-time.

Although the present invention has been described in considerable detail with reference to certain preferred embodiments thereof, other versions are possible. Therefore, the spirit and scope of the appended claims should not be limited to the description of the preferred embodiments contained herein.

What is claimed is:

1. A method for dataflow management in interactive communications networks, the method comprising the steps of:
determining characteristics of network components; and
managing dataflow in accordance with said determined characteristics.

2. A method for targeting content to users in a communications network; the method comprising the steps of:
determining targeted user characteristics; and
presenting content in accordance with said characteristics.

3. The method according to claim 1, for targeted content presentation in a communications network for regularly scheduled content opportunities, the method comprising the steps of:
monitoring the programming stream for opportunities and content descriptors;
determining the source for alternate content;
matching the opportunity to the available content and the viewer characteristics;
presenting content to the viewer; and
updating the secure audit log with the viewing result.

4. The method according to claim 2, further including the step of updating the secure audit log with the viewing result.

5. The method according to claim 1, for targeted content presentation in a communications network for functional/user interaction content opportunities, the method comprising the steps of:
monitoring the programming and content streams for opportunities and content descriptors;
pre-matching the opportunities to the available content and viewer characteristics;
determining the source for alternate content as described previously;
checking security rights at a function invocation to determine appropriateness of content insertion;
presenting the content to the viewer if appropriate; and
updating pre-matched opportunities for next function invocation.

6. The method according to claim 4, further including the step of updating the secure audit log with the viewing result.

7. A method according to claim 2, further including the steps of:
monitoring the content descriptor transmission stream;
matching the opportunity map descriptors with the receiver capabilities;
verifying that permission is available to access the content;
matching of the content descriptors to the viewer profile information;
selecting the descriptors with the strongest content match if local persistent storage is available to the MDE;
determining if the content is already in storage;
determining if the content can be acquired in a timely manner;
verifying access rights to storage if access rights are verified, verifying availability of storage;
determining if content can be deleted to make storage available by comparing matches of the new content with existing content in storage, and replacing content with weaker matches to make storage available;
acquiring content from the designated source; and
placing acquired content in storage.

8. The method according to claim 2, whereby the ME/DE also forwards configuration triggers that indicate to the MDE if certain components need to be replaced to enable dynamic adaptation of the system to new feedback algorithms, better functional capability, and/or component code fixes.

9. The method according to claim 2, whereby the MDE also receives profile characteristic information on the viewers from the operator.

10. The method according to claim 2, wherein the viewers profile data is encrypted to prevent unauthorized access.

11. The method according to claim 2, wherein the data is kept in encrypted format within the facilities of a CA system.

12. The method according to claim 2, wherein a plurality of instances of the MDE can be generated to match one or more of the capabilities and requirements of the system and the capabilities of the various receiver models on the network

13. A system for targeting content to users in a communications network comprising:
means for determining targeted user characteristics; and
means for presenting content in accordance with said characteristics.

14. The system according to claim 13, for targeted content presentation in a communications network, the system comprising:
a head end component having:
a content schedule component having:
a content schedule database; and
a content scheduler for accessing the content schedule database to provide schedule triggers;
a profile component having:
a profile database; and
a profile scheduler for accessing the profile database to provide profile triggers;
a matching engine for accessing the content schedule and profile components to match content to end-users;
a delivery engine for delivering the matched content; and
a combiner that receives the delivered matched content and combines it with available content streams;
a receiver component having:
a data filter for filtering data; and
a microdecision engine for providing the guidance and commands to present content to the end-user from the data filter; and
a data network between the head end and the end-user components for transmitting data.

15. The system according to claim 14, wherein the delivery engine is provided in a plurality of instances to provide for load balancing and capacity requirements.

16. A storage medium readable by a computer, the medium encoding a computer process to provide a method for targeted content presentation in a communications network, the computer process comprising:
a processing portion for determining targeted user characteristics; and
a processing portion for presenting content in accordance with said characteristics.

17. A system for dataflow management in interactive communications networks, the system comprising:
means for determining characteristics of network components; and
means for managing dataflow in accordance with said determined characteristics.

18. A storage medium readable by a computer, the medium encoding a computer process to provide a method for dataflow management in interactive communications networks, the computer process comprising:
a processing portion for determining characteristics of network components; and
a processing portion for managing dataflow in accordance with said determined characteristics.
